(19) United States
(12) Patent Application Publication
(10) Pub. No.: US 2021/0005069 A1
(43) Pub. Date: Jan. 7, 2021

(54) Abuse Alert System by Analyzing Sound

(71) Applicant: Aryan Mangal, Fremont, CA (US)

(72) Inventor: Aryan Mangal, Fremont, CA (US)

(73) Assignee: Aryan Mangal, Fremont, CA (US)

(21) Appl. No.: 16/920,657

(22) Filed: Jul. 4, 2020

Related U.S. Application Data
(60) Provisional application No. 62/870,654, filed on Jul. 3, 2019.

(51) Int. Cl. G08B 21/02; G10L 15/26; G10L 25/63; G10L 15/08

(52) U.S. Cl. CPC G08B 21/02; G10L 15/26; G10L 2015/088; G10L 15/08; G10L 25/63

(57) ABSTRACT

A method, including recognizing an indicia pattern on an audio signal recognizing its characteristics including but not limited to intensity, pitch, presence of abuse words, utilizing a portable device based sound controller system, prompting one of acceptance and disapproval of the indicia pattern, detecting a present of abuse intent and if intent is present, start taking an action e.g. recording, emailing or flashing an LED.

### TECHNICAL FIELD

This disclosure relates to sound monitoring, more particularly to a system of analysing sound and its various characteristics to detect abuse intent and report instances of potential abuse.

### BACKGROUND

In recent times, technology has advanced with a tremendous pace. The rapidly growing mobile electronics market, e.g. cellular phones, tablet computers, and PDAs, are an integral facet of modern life and has made audio monitoring more available as most portable electronics contain several microphones.

Together, with the development and supply of portable technology, an opportunity to utilize the audio data, generated by and readily available from the portable devices, has arisen. Along with this opportunity, several needs have also been identified. Namely, the need to prevent or deter abuse has shown promise when implemented on a portable technology platform e.g. mobile phones, tablets and purpose built devices.

Many prior solutions have been utilized to prevent or deter abuse. However, these prior solutions while attempting to prevent or deter abuse failed to detect and report abuse in an effective or usable way.

Illustratively for example, nanny cameras have been utilized to record behavior of an adult. Nanny cameras are also employed when abuse is suspected. However, nanny cameras are typically initiated by motion, time or both.

The nanny camera, therefore, does not identify abuse from other system detected motion. While nanny cameras will record, the record is generally large amounts of data. This data can induce computing problems by increasing processing overhead, memory overhead, and communications overhead by the whole sale capture of image and video any time a motion sensor or a timer are triggered.

The nanny camera also has large infrastructure overhead, fixed installations, and require preplanning. The nanny camera, therefore, lacks portability and cannot be used in every situation.

The amount of data captured by the nanny camera can be an impediment to the processing and detecting of abuse. Also, because there is no discrimination of action, the nanny camera will not provide abuse reporting or determination.

Solutions have been long sought but prior developments have not taught or suggested any complete solutions, and solutions to these problems have long eluded those skilled in the art. Thus there remains a considerable need for devices and methods that can provide reporting and detection of abuse.

### SUMMARY

An abuse alert system and methods, providing effective reporting and detection of abuse, are disclosed. The alert system and methods can include: retrieving audio from a user device; creating a voice map of the audio; correlating the voice map to a user; tagging the audio as correlated to the user; analyzing the audio for word identification; correlating identified words to known abusive language; analyzing the audio to establish an average decibel level; monitoring the audio for a decibel level above a threshold; recording and storing the audio based on the threshold being exceeded or the audio being correlated to the known abusive language.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE DRAWINGS

The alert system is illustrated in the figures of the accompanying drawings which are meant to be exemplary and not limiting, in which like reference numerals are intended to refer to like components, and in which:

FIG. 1 is a block diagram of the alert system.

FIG. 2 is a control flow for the alert system of FIG. 1.

FIG. 3 is the speaker identification step of FIG. 2.

FIG. 4 is the word trigger step of FIG. 2.

FIG. 5 is the sound level trigger step of FIG. 2.

FIG. 6 is block diagram of sensor system with machine learning live feedback display

FIG. 7 is illustration of how sound clips are recorded.

FIG. 8 is a control flow for the sensor system of FIG. 6

### DETAILED DESCRIPTION

In the following description, reference is made to the accompanying drawings that form a part hereof, and in which are shown by way of illustration, embodiments in which the alert system may be practiced. It is to be understood that other embodiments may be utilized and structural changes may be made without departing from the scope of the alert system.

When features, aspects, or embodiments of the alert system are described in terms of steps of a process, an operation, a control flow, or a flow chart, it is to be understood that the steps can be combined, performed in a different order, deleted, or include additional steps without departing from the alert system as described herein.

The alert system is described in sufficient detail to enable those skilled in the art to make and use the alert system and provide numerous specific details to give a thorough understanding of the alert system; however, it will be apparent that the alert system may be practiced without these specific details.

In order to avoid obscuring the alert system, some well-known system configurations, algorithms, and descriptions are not disclosed in detail. Likewise, the drawings showing embodiments of the system are semi-diagrammatic and not to scale and, particularly, some of the dimensions are for the clarity of presentation and are shown greatly exaggerated in the drawing FIGs.

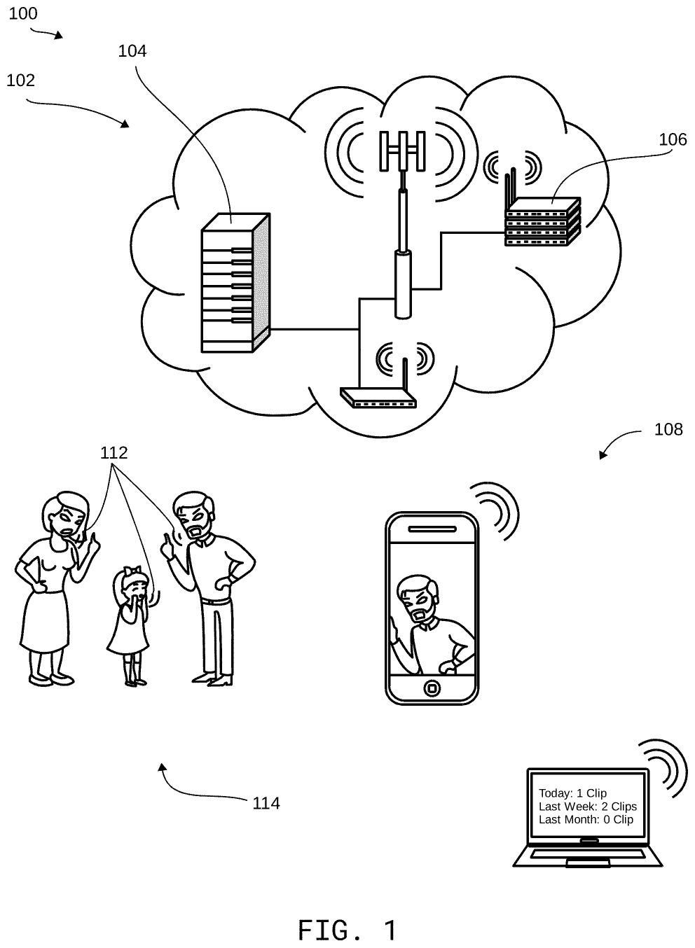

Referring now to FIG. 1, therein is shown a block diagram of the alert system 100. the alert system 100 can include elements of a distributed computing system 102 including servers 104, routers 106, and other telecommunications infrastructure.

The distributed computing system 102 can include the Internet, a wide area network (WAN), a metropolitan area network (MAN), a local area network (LAN), a telephone network, cellular data network (e.g., 3G, 4G, 5G) and/or a combination of these and other networks (wired, wireless, public, private or otherwise).

The servers 104 can function both to process and store data for use on user devices 108 including laptops, cellular phones, and tablet computers. It is contemplated that the servers 104 and the user devices 108 can individually comprise a central processing unit, memory, storage and input/output units and other constituent components configured to execute applications including software suitable for displaying user interfaces, the interfaces optionally being generated by a remote server, interfacing with the cloud network, and managing or performing capture, transmission, storage, analysis, display, or other processing of data and or images.

The servers 104 and the user devices 108 of the alert system 100 can further include a web browser operative for, by way of example, retrieving web pages or other markup language streams, presenting those pages or streams, executing scripts, controls and other code on those pages or streams, accepting user input with respect to those pages or streams, and issuing HTTP requests with respect to those pages or streams. The web pages or other markup language can be in HAML, CSS, HTML, Ruby on Rails or other conventional forms, including embedded XML, scripts, controls, and so forth as adapted in accord with the teachings hereof. The user devices 108 and the servers 104 can be used individually or in combination to store and process information from the alert system 100 in the form of operation method steps such as detecting steps, calculating steps, and displaying steps.

The user devices 108 can also be audio-capturing devices, such as the edge device microcontroller e.g. arduino or Raspberry PI, cellular phone, the laptop, or the tablet computer. It is contemplated that the audio-capturing device can be any device suitable for acquiring audio and communicating the audio to the distributed computing system 102.

The user devices 108 can be used to capture, analyze, and communicate audio 112 from users 114. The users 114 can be adults or children, and the audio 112 can be the sound produced by the people within the vicinity of the user device 108.

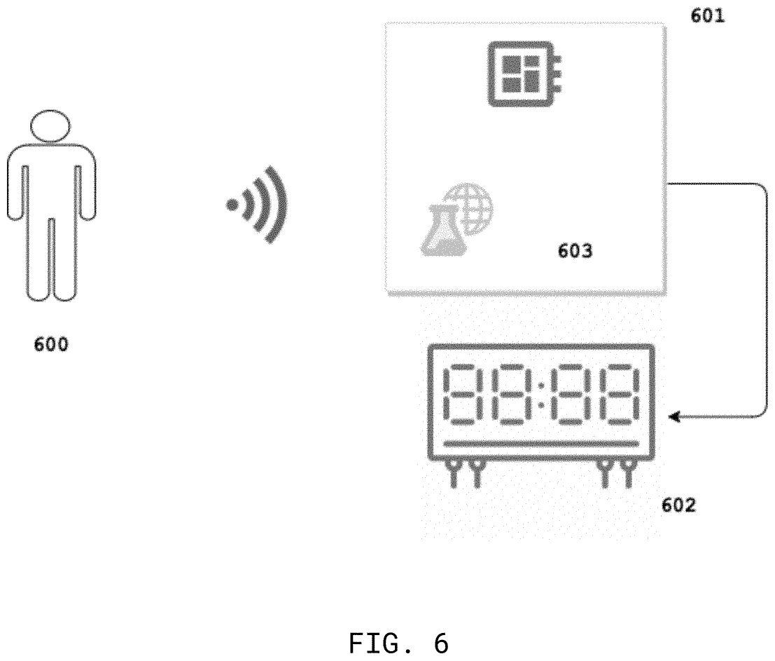

In some embodiments, referring FIG. 6, User device 601 may be equipped with edge processing capabilities e.g. capability to execute computing machine learning models and run analysis of the sound input on the user device board locally. If such capability is present, a pre-trained model could be uploaded in the memory of the user device 601.

Such user device 601, after analysis can provide visual feedback 602 in realtime in the form of a display 602 e.g. flashing LED or showing a message on screen or making loud sound discouraging the root cause.

It is contemplated that the alert system 100 could collect the audio 112 from the user 114 and could transform the physical audio signals into a dashboard for displaying instances when the audio 112 has triggered the alert system 100, as discussed below. Illustratively, for example, the display could include a number of audio clips recorded in the last day, last week, and last month.

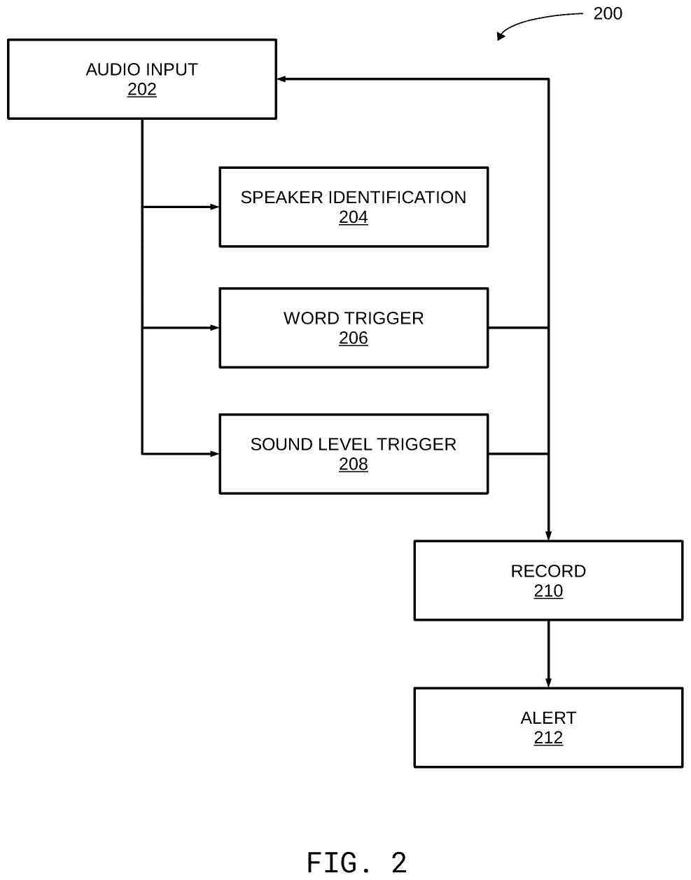

Referring now to FIG. 2, therein is shown a control flow 200 for the alert system 100 of FIG. 1. The alert system 100 can initiate an audio input step 202.

The audio input step 202 can retrieve the audio signals from microphones within the user device 108 of FIG. 1. The audio signals can be converted into digital audio data within the user device 108. For ease of description, the audio 112 of FIG. 1 will be used herein to generically refer to the digital audio data and the audio signals collectively unless it becomes apparent from the context, in which the term is employed, that the term refers to a particular audio element.

It is contemplated that the alert system 100 could be configured to run as a background application on the user device 108. That is, the alert system 100 can collect the audio while the user device 108 is in use by the users 114 of FIG. 1; or in the alternative, not in use by the users 114. It is contemplated that the alert system 100 can passively collect and then analyze audio data from the user device 108 even without the users 114 knowing the alert system 100 is executing the audio input step 202.

Once the alert system 100 has collected the audio 112 within the audio input step 202, the alert system 100 can execute a speaker identification step 204, a word trigger step 206, and a sound level trigger step 208 in parallel. It is contemplated that some embodiments could include the speaker identification step 204, the word trigger step 206, or the sound level trigger step 208 being serially performed after a delay.

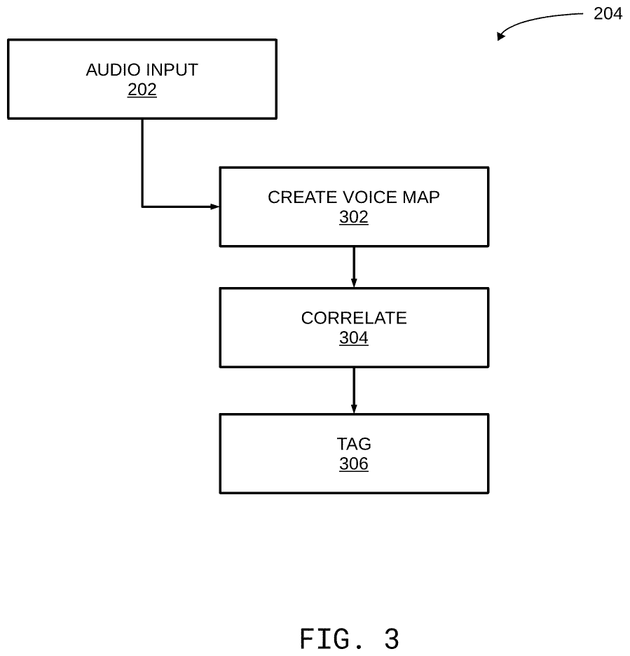

The speaker identification step 204 will be discussed with regard to FIG. 3 below; however, generally speaking the speaker identification step 204 can identify and flag a speaker of the audio 112. It is also contemplated that the speaker identification step 204 could be an optional step being performed only if computational resources are available.

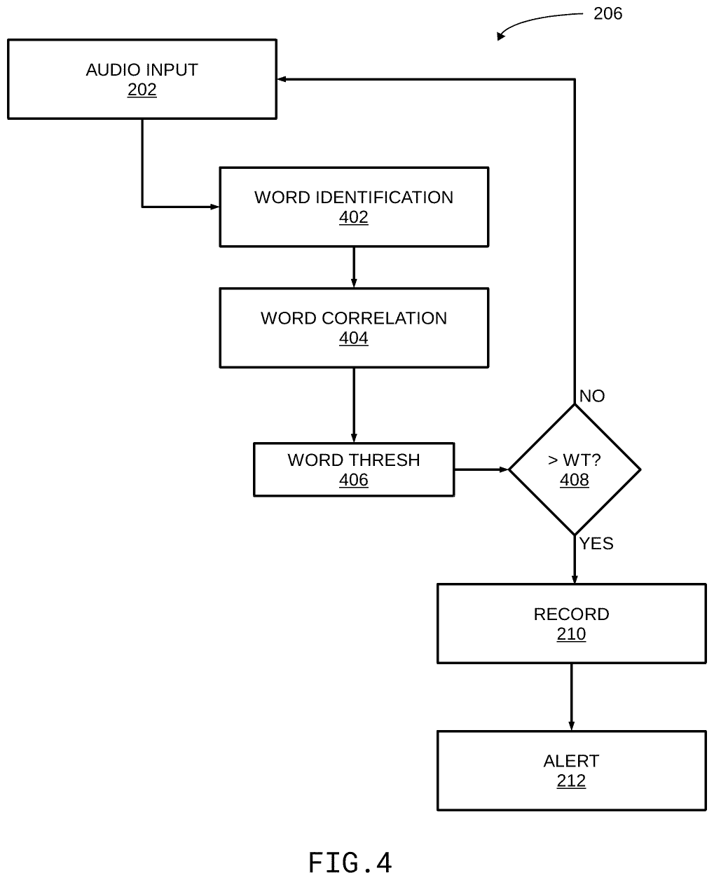

Alternatively it is contemplated that the speaker identification step 204 could be utilized only when a speaker could be positively identified. The word trigger step 206 will be discussed with regard to FIG. 4 below. The word trigger step 206 can trigger when predefined words are detected.

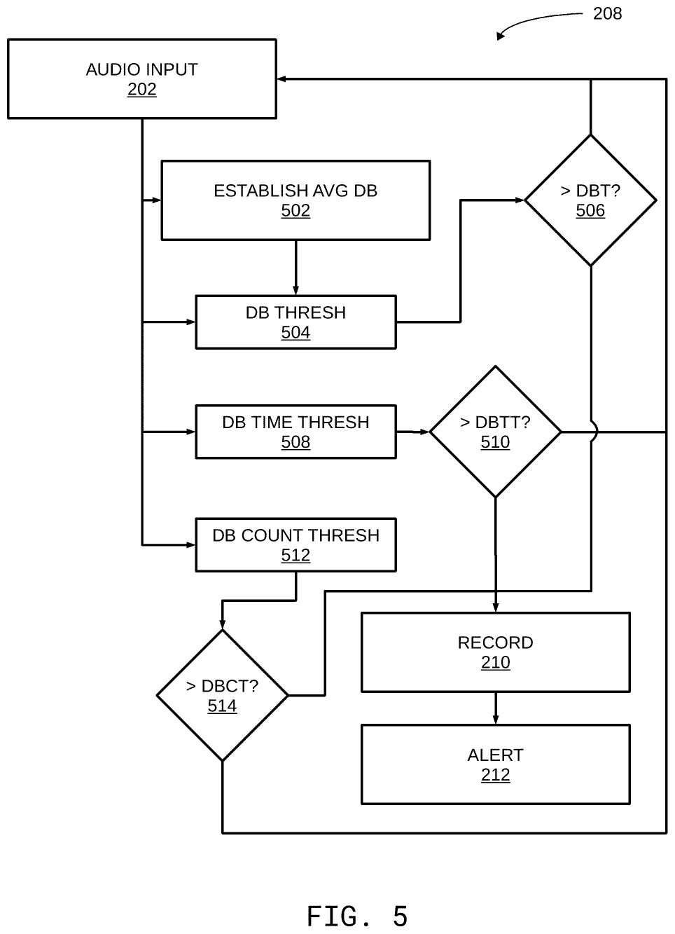

The sound level trigger step 208 will be discussed with regard to FIG. 5 below. The sound level trigger step 208 can trigger when noise thresholds are exceeded. Once triggered, the alert system 100 can initiate the record step 210.

The record step 210 can record the audio 112 to a computer readable medium within the user device 108. During the record step 210 the audio 112 could be tagged with the user 114 identified within the speaker identification step 204 and could be tagged with the threshold exceeded during the word trigger step 206 or the sound level trigger step 208.

The alert step 212 can send the audio 112 within an email or within a text message to all listed subscribers. The subscribers could include a parent, teacher, friend or guardian. It has been discovered that abuse can be detected, reported, documented, and ultimately curtailed because the alert system 100 can be continually running within the background of the user device 108.

The alert system 100 is not intended to be limited to child abuse. Rather, the alert system 100 can be implemented to detect abuse in many different types of relationships.

Illustratively, for example, the alert system 100 can detect, report, and document the attributes health and activities of old age people. This can be accomplished, for example, by detecting lack of noise around.

Alert system 100 can also detect and record the conversation audio clips as evidence, verbal abuse cases that are short and are found in but not limited to abusive relationships.

Further, the absence or delayed arrival of teachers in classrooms can be detected, reported and documented based on the alert system 100 detecting increased noise in classroom between the periods.

Referring now to FIG. 3, therein is shown the speaker identification step 204 of FIG. 2. The speaker identification step 204 can begin with an input of the audio 112 of FIG. 1 from the audio input step 202.

The audio 112 can be retried from the audio input step 202 and can be analyzed within the voice map step 302. The voice map step 302 can detect voice and auditory markers to create a voiceprint of a voice detected within the audio 112.

Once the voiceprint is created within the voice map step 302, the alert system 100 can compare the voiceprint to a group of voiceprints for known users within a correlate voice step 304. Once the voiceprint from the audio 112 is correlated with a known voiceprint, the alert system 100 can tag the audio 112 with the user 114 of FIG. 1 associated with the voiceprint identified in a tag step 306.

It is contemplated that the speaker identification step 204 can be an optional step. It is further contemplated that the speaker identification step 204 can run continuously on the alert system 100 but only tag the audio 112 if one of the users 114 is positively identified as a speaker of the voiceprint.

Referring now to FIG. 4, therein is shown the word trigger step 206 of FIG. 2. The word trigger step 206 can be initiated by the alert system 100 with an input of the audio 112 of FIG. 1 within the audio input step 202.

The audio 112 can be input to a word identification step 402. The word identification step 402 can analyze the audio 112 for words within the word identification step 402.

The word identification step 402 can employ one of two types of speech recognition. Illustratively, the word identification step 402 could employ speaker-dependent or speaker-independent speech recognition.

Speaker-dependent speech recognition can learn unique characteristics of a single user's 114 voice. In this implementation, it is contemplated that new users 114 would first need to train the alert system 100 for recognizing how the individual new user 114 talks.

Speaker-independent speech recognition can be used to recognize any user's 114 voice with no training. Although speaker-independent speech recognition is generally less accurate than the speaker-dependent approach, the seeker-independent can be effectively utilized by the alert system 100 since only a small number of words are of concern.

That is, the words identified within the word identification step 402 can be correlated within a correlate word step 404 with prohibited words including: cuss words, words of abuse, or words of aggression. By using a materially limited set of prohibited words, the word identification step 402 can be more likely to correctly recognize what the user 114 said and more likely to correctly correlate the word identified with a prohibited word within the correlate word step 404.

The correlate word step 404 can identify which of the words detected within the word identification step 402 are prohibited words within the correlate word step 404. The prohibited words detected can be ranked according to their propensity to precede abuse within the correlate word step 404.

It is contemplated, for example, that the word “stupid” or “fat” could be ranked with a 5 for being highly likely to precede abuse, while the word “mean” or “rude” could be ranked with a 1 for being highly unlikely to precede abuse.

The prohibited words, which were identified and ranked, can be evaluated against a word threshold 406 within an exceed word threshold decision step 408. If the rank of the prohibited word exceeds the word threshold 406, the exceed word threshold decision step 408 can output an affirmative result and the alert system 100 can execute the record step 210 and the alert step 212.

The record step 210 can record the audio 112 containing the prohibited word exceeding the word threshold 406. The alert step 212 can send the audio 112 containing the prohibited word to the users 114 that have subscribed to the alert system 100.

If the rank of the prohibited word does not exceed the word threshold 406, the exceed word threshold decision step 408 can output a negative result and the alert system 100 can execute the audio input step 202 again.

It is contemplated that the prohibited words could be tracked over time. In this implementation, once the cumulative ranks of the detected prohibited words exceed the word threshold 406, the exceed word threshold decision step 408 could provide the affirmative result and initiate the record step 210 and the alert step 212.

It is yet further contemplated that the prohibited words could be tracked, and their ranks accumulated for each of the users 114 identified within the speaker identification step 204 of FIG. 2. It is still further contemplated that the prohibited word could be tracked based on the time when they were spoken, and the word threshold 406 could be a threshold for a cumulative rank of the prohibited words over a time period.

Referring now to FIG. 5, therein is shown the sound level trigger step 208 of FIG. 2. The sound level trigger step 208 can be initiated by the alert system 100 with an input of the audio 112 of FIG. 1 within the audio input step 202.

The alert system 100 could begin the sound level trigger step 208 with an average DB step 502. The average DB step 502 could determine an average decibel level for the environment within which the user device 108 is presently operating in.

Once the average decibel level has been established within the average DB step 502, the alert system 100 can evaluate the current decibel level with a DB threshold 504 within an exceed DB threshold decision step 506. It is contemplated that the DB threshold 504 could be a relative threshold based on the average decibel level detected within the average DB step 502.

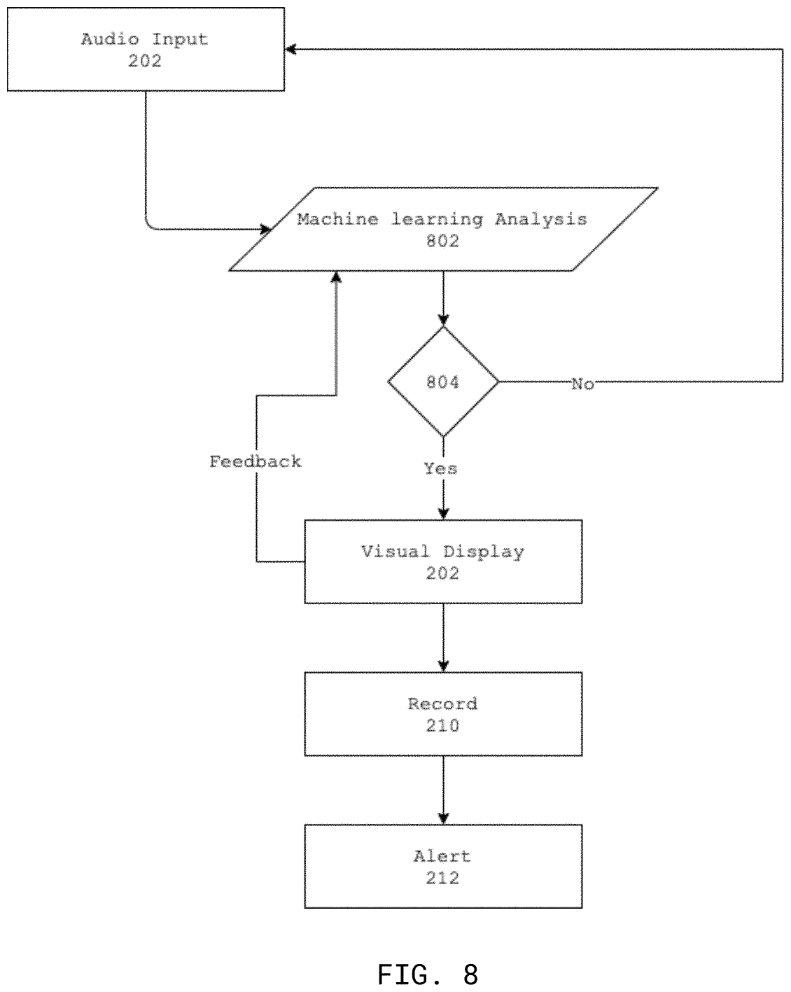

Referring now to FIG. 8, therein shows the real time analysis of sound signal using machine learning model. The abuse word alert trigger step 804 can be initiated by the alert system 100 with an input of the audio 112 of FIG. 1 within the audio input step 202.

Such machine learning model that can be trained to adapt to internationalization and trained to work in different languages and localized for specific local dialects, contemporary and frequently used words, phrases and slangs and personalized to individual needs concerned around certain trigger words, tones or sound pitches.

Illustratively, for example, the DB threshold 504 could be 10% and any sound detected within the audio input step 202 larger than the 10% DB threshold 504 would return an affirmative result within the exceed DB threshold decision step 506.

An affirmative result at the exceed DB threshold decision step 506 would cause the alert system 100 to initiate the record step 210 and the alert step 212. The alert system 100 could alternatively or in addition, evaluate the audio 112 against a DB time threshold 508 within an exceed DB time threshold decision step 510.

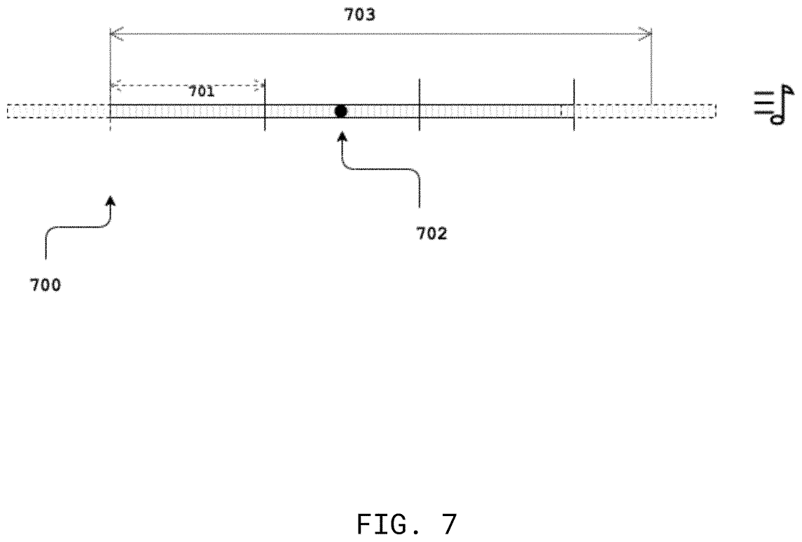

With Ref to FIG. 7, It is important to preserve the context of the sound recording 700. To achieve this, recording system 100 could continuously record temporary small clips discarding the older ones as new ones are created. As any of the triggers 702 as discussed in 408, 506, 510, 802 are detected, actual recording 703 can include the clip from past 701 temporary recording shown in FIG. 7.

Illustratively, for example, the audio 112 could be analyzed against the average DB of the audio 112 over a time period. This audio 112 over the time period could be compared to the DB time threshold 508, and when the DB time threshold 508 is exceeded during a time period, the alert system 100 will execute the record step 210 and the alert step 212.

The alert system 100 could alternatively or in addition, evaluate the audio 112 against a DB count threshold 512 within an exceed DB count threshold decision step 514. Illustratively, for example, the audio 112 could be analyzed against a DB count. Each time the audio 112 rose above the average DB level within a time period would be counted.

The count of each time the audio 112 rises above the average DB level, can be compared to the DB count threshold 512. Once the DB count threshold 512 is exceeded, the exceed DB count threshold decision step 514 could return an affirmative result and initiate the record step 210 and the alert step 212. If the exceed DB time threshold decision step 510, exceed DB threshold decision step 506, or the exceed DB count threshold decision step 514 return a negative result, the alert system 100 will again execute the audio input step 202.

Thus, it has been discovered that the alert system furnishes important and heretofore unknown and unavailable solutions, capabilities, and functional aspects. The resulting configurations are straightforward, cost-effective, uncomplicated, highly versatile, accurate, sensitive, and effective, and can be implemented by adapting known components for ready, efficient, and economical manufacturing, application, and utilization.

While the alert system has been described in conjunction with a specific best mode, it is to be understood that many alternatives, modifications, and variations will be apparent to those skilled in the art in light of the preceding description. Accordingly, it is intended to embrace all such alternatives, modifications, and variations, which fall within the scope of the included claims. All matters set forth herein or shown in the accompanying drawings are to be interpreted in an illustrative and non-limiting sense.

What is claimed is:

1. A method, comprising:
recognizing an indicia pattern of abuse detection through analysing various characteristics of sound;
prompting one of acceptance and disapproval of the indicia pattern determining abusal intent;
start recording a sound clip from a sound input if the abuse detection indicia pattern is accepted;
generate alert and send communication in any desirable format as configured; and
prompting one of confirmation and refusal of the pairing.

2. The method of claim 1, further comprising detecting voice intensity by measuring any or all of amplitude, pitch to at least one of accept the indicia pattern and disapprove the indicia pattern.

3. The method of claim 1, further comprising detecting voice intensity can be tuned based on person, environment, surrounding noise level and other factors that can impact sound detection.

4. The method of claim 1, further comprising detecting voice intensity duration to at least one of confirm the abuse and refuse the abuse.

5. The method of claim 1, further comprising detecting presence of abusive words by converting voice to text to at least one of confirm the abuse and refuse the abuse.

6. In addition to claim 4, ability to choose and personalize abusive or derogatory words is also claimed.

7. The method of claim 1, further comprising machine learning models that can be miniaturized in size and can be fit onto portable devices such as microcontrollers, mobile phone, tablets with the sole purpose of abuse detection.

8. Adding to claim 7, a feedback loop display that can provide immediate feedback in the form of either visual or voice.

9. The method of claim 1, wherein the sound collection device is at least one of microcontroller boards with microphone, mobile phone or other similar handheld with recording capability.

10. The method of claim 1, wherein the wireless connectivity is at least one of one of a low power wide area network device (LPWAN), a wifi network, a long term evolution for machines (LTE-M) device, a category M1 (Cat M1) device or a narrow band internet of things (NB-IoT) network.

11. The method of claim 1, wherein the recorded sound clip can be uploaded onto the desired system of record such as cloud or personal hard drive.

12. The method of claim 1, wherein the recorded clip extends before and after of the abuse trigger by a preset period of time which can be adjusted.

13. A system, comprising:
a sound recording device having a non-transitory computer readable storage medium that stores instructions that when executed causes a mobile device processor to:
start recording when desired conditions of voice intensity, duration and words match send alert notification in case indicia pattern on the input voice
send alert notification in case indicia pattern on the input voice is matched;
complete the recording and create clip few seconds after abuse detection indicia pattern is no more present;
synchronize the recorded voice clips to the cloud.

14. A sensor system for detecting abuse in real time, the sensor system comprising:
microcontroller board equipped with voice recorder to be able to record input sound;
a machine learning chip that is capable of storing and executing machine learning models on live incoming sound;
a non-transitory storage medium to be able to store sound clips; a feedback system in form a audio or visual aid and a network interface configured to transfer recorded sound flies.

15. The system of claim 13, wherein the sensor system detects abuse intention, feedback loop in form of a LED display or a siren that can provide sensible signal an optical flashing, an audible sound, or combination thereof and deter the cause of abuse.

16. The system of claim 13, further comprising a compute device capable of creating, compressing personalised machine learning models and connecting with micro-controller of the sensor system for maintenance and upgrade.

17. The system of claim 13, wherein sensor system is powered by a portable onboard power supply.
